(19) United States
(12) Patent Application Publication
(10) Pub. No.: US 2012/0026111 A1
(43) Pub. Date: Feb. 2, 2012

(54) INFORMATION PROCESSING APPARATUS, INFORMATION PROCESSING METHOD, AND COMPUTER PROGRAM

(76) Inventors: Shunichi Kasahara, Kanagawa (JP); Tomoya Narita, Kanagawa (JP); Ritsuko Kano, Tokyo (JP)

(21) Appl. No.: 13/163,639

(22) Filed: Jun. 17, 2011

(30) Foreign Application Priority Data
Jul. 28, 2010 (JP) P2010-169104

(51) Int. Cl. G06F 3/041

(52) U.S. Cl. 345/173

(57) ABSTRACT

The present disclosure provides an information processing apparatus including, a detection unit configured to detect the position of an operating body relative to a display surface of a display unit displaying an object group made up of a plurality of objects each being related to a content, and a display change portion configured to change a focus position of the objects making up the object group based on a result of the detection performed by the detection unit, wherein if the result of the detection by the detection unit has detected the operating body moving linearly in a predetermined operating direction thereof substantially parallel to the display surface, then the display change portion changes the focus position of the objects spread out circularly to make up the object group, in a manner moving the focus position in the spread-out direction.

### BACKGROUND

The present disclosure relates to an information processing apparatus, an information processing method, and a computer program.

Because of their intuitive, easy-to-use user interface (UI), touch panels have been used extensively in such applications as ticket vendors for public transportation and automatic teller machines (ATM) used by banks. In recent years, some touch panels have become capable of detecting users' motions and thereby implementing device operations heretofore unavailable with existing button-equipped appliances. The newly added capability has recently prompted such portable devices as mobile phones and videogame machines to adopt their own touch panels. For example, Japanese Patent Laid-Open No. 2010-55455 discloses an information processing apparatus which, by use of a touch panel-based user interface, allows a plurality of images to be checked efficiently in a simplified and intuitive manner.

### SUMMARY

Thumbnail representation is effective as a user interface that provides a quick, comprehensive view of contents to be browsed efficiently over a plurality of screens being checked. On the other hand, where there exist large quantities of contents to be viewed, thumbnail representation can make it difficult for the user to grasp related contents in groups or get a hierarchical view of the contents. When a plurality of contents are classified into a group and related to a folder and a thumbnail for representation purposes, a macroscopic overview of the contents may be improved. However, where the contents are put into groups in an aggregate representation, it may be difficult to view the contents individually.

If related contents are defined as a group and such content groups are structured in a hierarchical representation for viewing of the contents, it can become difficult to check the contents individually as they remain represented as part of the content groups.

The present disclosure has been made in view of the above circumstances and provides an information processing apparatus, an information processing method, and a computer program with novel improvements for permitting easy viewing of contents that constitute groups.

According to one embodiment of the present disclosure, there is provided an information processing apparatus including: a detection unit configured to detect the position of an operating body relative to a display surface of a display unit displaying an object group made up of a plurality of objects each being related to a content; and a display change portion configured to change a focus position of the objects making up the object group based on a result of the detection performed by the detection unit; wherein, based on the result of the detection, if said detection unit has detected the operating body moving linearly in a predetermined operating direction thereof substantially parallel to the display surface, then the display change portion changes the focus position of the objects spread out circularly to make up the object group, in a manner moving the focus position in the spread-out direction.

Preferably, the display change portion may change the format in which the object group is displayed based on a proximate distance between the display surface and the operating body, the proximate distance being acquired from the result of the detection performed by the detection unit.

Preferably, based on the result of the detection, if said detection unit has detected the operating body moving in a direction substantially perpendicular to the predetermined operating direction, then the display change portion may determine to select the content related to the currently focused object.

Preferably, the display change portion may change the focus position of the objects making up the object group in accordance with the amount by which the operating body has moved relative to the display surface.

Preferably, the object group may be furnished with a determination region including the objects; the determination region may be divided into as many sub-regions as the number of the objects included in the object group, the sub-regions corresponding individually to the objects; and the display change portion may focus on the object corresponding to the sub-object on which the operating body is detected to be positioned based on the result of the detection performed by the detection unit.

Preferably, the display change portion may change the determination region in such a manner as to include the content group in accordance with how the content group is spread out.

Preferably, if the operating body is detected to have moved out of the determination region based on the result of the determination performed by the detection unit, then the display change portion may display in aggregate fashion the objects making up the object group.

Preferably, the display change portion may highlight the currently focused object.

Preferably, the display change portion may display the currently focused object close to the tip of the operating body.

Preferably, if an operation input is not detected for longer than a predetermined time period based on the result of the detection performed by the detection unit, then the display change portion may stop changing the focus position of the objects making up the object group.

According to another embodiment of the present disclosure, there is provided an information processing method including: causing a detection unit to detect the position of an operating body relative to a display surface of a display unit displaying an object group made up of a plurality of objects each being related to a content; causing a display change portion to change a focus position of the objects making up the object group based on a result of the detection performed by the detection unit; and based on the result of the detection, if said detection unit has detected the operating body moving linearly in a predetermined operating direction thereof substantially parallel to the display surface, then causing the display change portion to change the focus position of the objects spread out circularly to make up the object group, in a manner moving the focus position in the spread-out direction.

According to a further embodiment of the present disclosure, there is provided a computer program for causing a computer to function as an information processing apparatus including: a detection unit configured to detect the position of an operating body relative to a display surface of a display unit displaying an object group made up of a plurality of objects each being related to a content; and a display change portion configured to change a focus position of the objects making up the object group based on a result of the detection performed by the detection unit; wherein, based on the result of the detection, if said detection unit has detected the operating body moving linearly in a predetermined operating direction thereof substantially parallel to the display surface, then the display change portion changes the focus position of the objects spread-out circularly to make up the object group, in a manner moving the focus position in the spread-out direction.

The program may be stored in a storage device attached to the computer and may be read therefrom by the CPU of the computer for program execution, which enables the computer to function as the information processing apparatus outlined above. There may also be provided a computer-readable recording medium on which the program is recorded. For example, the recording medium may be a magnetic disk, an optical disk, or a magneto-optical (MO) disk. The magnetic disk comes in such types as hard disks and circular-shaped magnetic body disks. The optical disk comes in such types as CD (Compact Disc), DVD-R (Digital Versatile Disc Recordable), and BD (Blu-Ray Disc (registered trademark)).

As outlined above, the present disclosure offers an information processing apparatus, an information processing method, and a computer program for facilitating the viewing of the contents making up a content group.

### BRIEF DESCRIPTION OF THE DRAWINGS

FIG. 1 is a block diagram showing a typical hardware structure of an information processing apparatus implemented as an embodiment of the present disclosure;

FIG. 2 is an explanatory view showing a typical hardware structure of the information processing apparatus as the embodiment;

FIG. 3 is an explanatory view outlining a content group display operation process performed by the information processing apparatus as the embodiment;

FIG. 4 is an explanatory view showing proximate states of a user's finger during the content group display operation process;

FIG. 5 is a block diagram showing a functional structure of the information processing apparatus as the embodiment;

FIG. 6 is a flowchart showing a typical process for changing content group display performed by the embodiment;

FIG. 7 is an explanatory view showing a typical determination region;

FIG. 8 is an explanatory view showing another typical determination region;

FIG. 9 is an explanatory view showing typical operations to change the focused content pile;

FIG. 10 is an explanatory view showing typical operations to change the focused content pile where a focus position determination region is established;

FIG. 11 is an explanatory view showing other typical operations to change the focused content pile where the focus position determination region is established;

FIG. 12 is an explanatory view showing other typical operations to change the focused content pile in accordance with the operating body's position on the display surface;

FIG. 13 is an explanatory view showing typical operations to execute the function related to a content group or to a content;

FIG. 14 is an explanatory view showing an example in which a content group is spread out when displayed; and

FIG. 15 is an explanatory view showing another example in which a content group is spread out when displayed.

### DETAILED DESCRIPTION OF THE PREFERRED EMBODIMENTS

Some preferred embodiments of the present disclosure will now be described in detail in reference to the accompanying drawings. Throughout the ensuing description and the accompanying drawings, the component parts having substantially the same functional structures are designated by the same reference numerals and their explanations will be omitted where redundant.

The description will be given under the following headings:

1. Structure of the information processing apparatus and the display changing process performed thereby; and

2. Variations.

### <1. Structure of the Information Processing Apparatus and The Display Changing Process Performed Thereby>

### [Typical Hardware Structure of the Information Processing Apparatus]

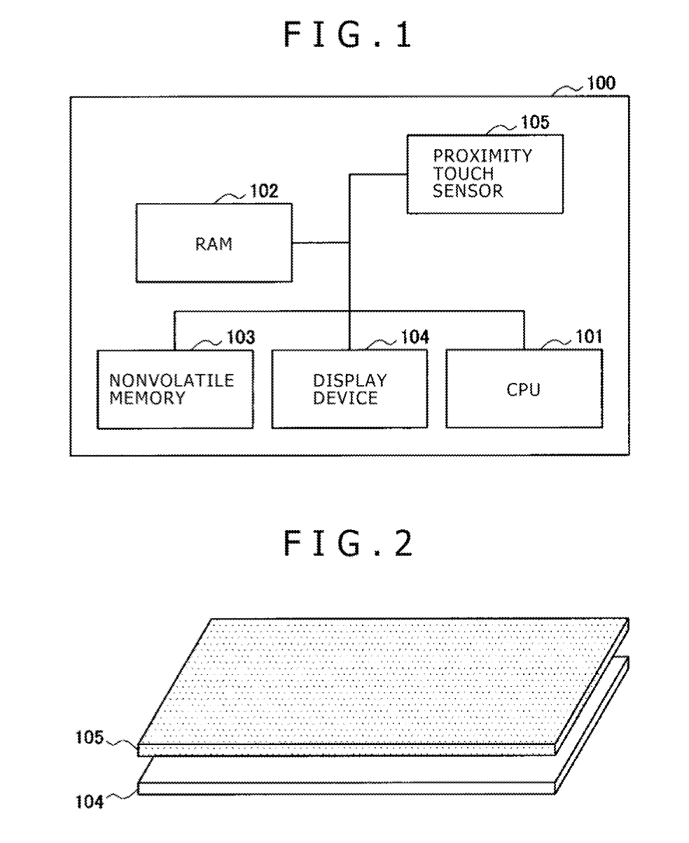

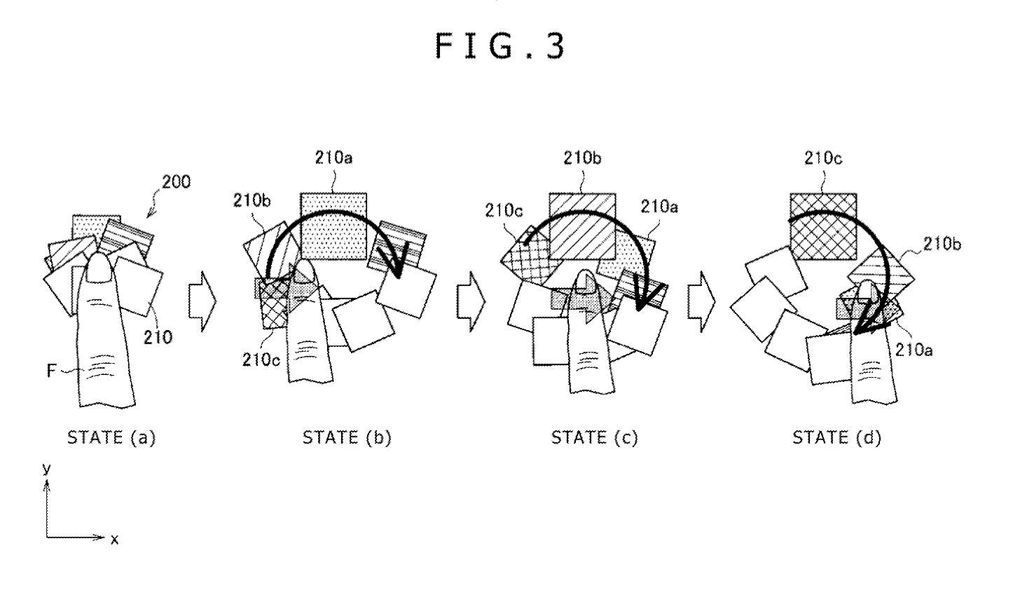

Described first in reference to FIGS. 1 and 2 is a typical hardware structure of an information processing apparatus 100 implemented as a first preferred embodiment of the present disclosure. FIG. 1 is a block diagram showing a typical hardware structure of the information processing apparatus 100 embodying the disclosure. FIG. 2 is an explanatory view illustrating a typical hardware structure of the information processing apparatus 100 as the preferred embodiment.

The information processing apparatus 100 as the preferred embodiment has a detection unit capable of detecting the contact position of an operating body on the display surface of a display device. The detection unit is further capable of detecting the proximate distance between the display surface of the display device and the operating body located above the display surface. The information processing apparatus 100 comes in diverse sizes with diverse functions. The variations of such apparatus may include those with a large-sized display device such as TV sets and personal computers and those with a small-sized display device such as portable information terminals and smart phones.

As shown in FIG. 1, the information processing apparatus 100 as the preferred embodiment includes a CPU 101, a RAM (random access memory) 102, a nonvolatile memory 103, a display device 104, and a proximity touch sensor 105.

The CPU 101 functions as an arithmetic processing unit and a control unit as mentioned above, controlling the overall performance of the information processing apparatus 100 in accordance with various programs. The CPU 101 may be a microprocessor, for example. The RAM 102 temporarily stores the programs being executed by the CPU 101 as well as the parameters being varied during the execution. These hardware components are interconnected via a host bus typically composed of a CPU bus. The nonvolatile memory 103 stores the programs and operation parameters for use by the CPU 101. For example, the nonvolatile memory 103 may be a ROM (read only memory) or a flash memory.

The display device 104 is a typical output device that outputs information. For example, a liquid crystal display (LCD) device or an OLED (organic light emitting diode) device may be adopted as the display device 104. The proximity touch sensor 105 is a typical input device through which the user inputs information. The proximity touch sensor 105 is typically made up of an input section for inputting information and of an input control circuit for generating an input signal based on the user's input and outputting the generated signal to the CPU 101.

On the information processing apparatus 100 as the preferred embodiment, the proximity touch sensor 105 is mounted on the display surface of the display device 104 as shown in FIG. 2. Thus positioned, the proximity touch sensor 105 can detect the distance between the user's finger approaching the display surface on the one hand, and the display surface on the other hand.

In the ensuing paragraphs, the information processing apparatus 100 embodying the present disclosure will be described as an apparatus structured as outlined above, but the present disclosure is not limited thereby. For example, the information processing apparatus may be furnished with an input device capable of pointing and clicking operations on the information displayed on the display device. It should be noted that the proximity touch sensor 105 capable of detecting the proximate distance between the display surface and the user's finger and attached to the preferred embodiment can detect three-dimensional motions of the finger. This permits input through diverse operations. As another alternative, there may be provided an information processing apparatus capable of detecting the contact position of the operating body on the display surface as well as the pressure exerted by the operating body onto the display surface.

### [Input of Operation Information to the Information Processing Apparatus]

The information processing apparatus 100 as outlined above changes the format in which the content group made up of a plurality of contents is displayed on the display device 104 in keeping with the proximate distance between the display surface and the operating body. The information processing apparatus 100 also changes the currently focused content in accordance with the position of the operating body. These functions allow the user to change the format in which the content group is displayed as well as the focus position by suitably moving his or her operating body above the display surface displaying the content group, e.g., by bringing the operating body close to or away from the display surface, or by moving the operating body substantially in parallel with the display surface.

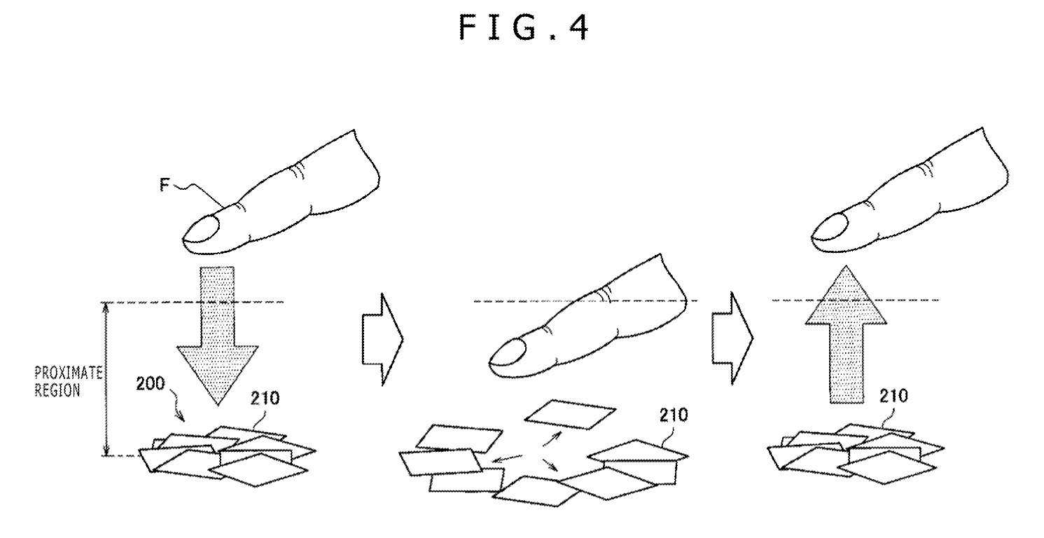

Outlined below in reference to FIGS. 3 and 4 is the way the information processing apparatus 100 as the preferred embodiment typically performs its content group display operation process. FIG. 3 is an explanatory view outlining the content group display operation process performed by the information processing apparatus 100 as the preferred embodiment. FIG. 4 is an explanatory view showing proximate states of a user's finger during the content group display operation process. When the finger F is sufficiently distant from the display surface and out of the proximate region as shown in state (a) of FIG. 3 and in the left-hand subfigure of FIG. 4, a content group 200 is displayed in such a manner that content piles 210 making up the content group 200 are overlaid with one another and aggregated in a single position. From the information written on the content pile 210 at the top of the content group 200, the user can recognize the connection between the content piles 210 included in the content group 200.

As the user brings his or her finger F close to the display surface and positions it in the proximate region, the content group 200 appears spread out and the information written on each of the content piles 210 making up the content group 200 becomes visible, as shown in the center part of FIG. 4. At this point, one of the content piles 210 constituting the content group 200 is being focused. As shown in state (b) of FIG. 3, the focused content pile 210 is displayed larger than the other content piles 210. If, for example, the information written on the focused content pile 210 is also displayed enlarged, the user can clearly recognize the information on that content pile 210. Alternatively, a larger amount of information may be displayed on the focused content pile 210 than on the other content piles 210. This will allow the user to acquire more information about the focused content pile 210. When the user subsequently brings the finger F away from the display surface and out of its proximity region, the content piles 210 are again displayed aggregated and overlaid with one another as shown in the right-hand subfigure of FIG. 4.

With finger F positioned in the proximate region and with the content group 200 shown spread out, moving the finger F substantially in parallel with the display surface changes the currently focused content pile 210 in the content group 200. For example, when the content group 200 is spread out circularly from its aggregate state as shown in state (b) of FIG. 3, a content pile 210a may be focused and displayed enlarged. The other content piles (210b, 210c, . . . ) are displayed smaller than the focused content pile 210a. When the user moves the finger F rightward as viewed on the plan view (in the positive X-axis direction) from state (b), the circularly displayed content piles 210 are rotated clockwise to reach state (c). In state (c), the object of focus is shifted from the content pile 210a to another content pile 210b. When the user further moves the finger F rightward (in the positive X-axis direction) from state (c), the circularly displayed content piles 210 are further rotated clockwise to reach state (d). In state (d), the object of focus is shifted from the content pile 210b to yet another content pile 210c.

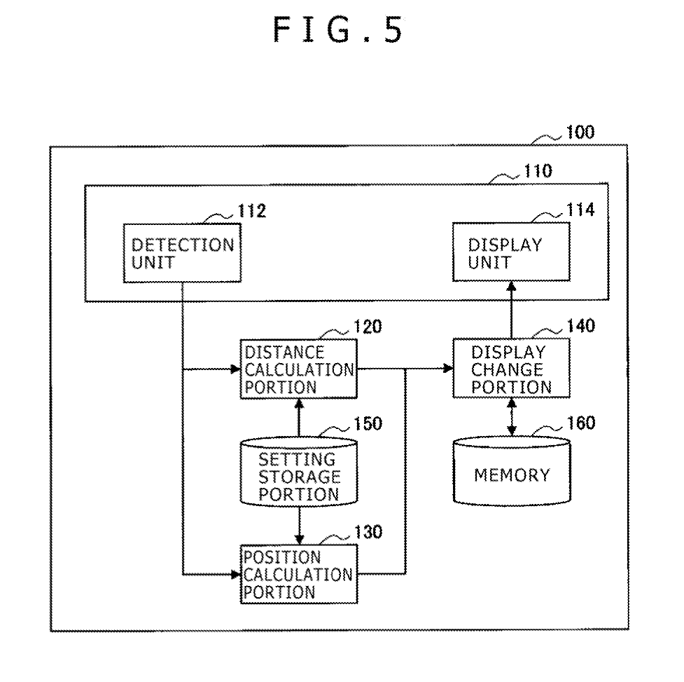

In the manner described above, the user can move his or her finger F to change the format in which the content group 200 is displayed, as well as the focus position of the contents making up the content group. Described below in detail in reference to FIGS. 5 through 15 is a typical functional structure of the information processing apparatus 100 as the preferred embodiment of the present disclosure, along with a content group display changing process carried out by the information processing apparatus 100.

### [Functional Structure]

The functional structure of the information processing apparatus 100 as the preferred embodiment is first explained below in reference to FIG. 5. FIG. 5 is a block diagram showing a typical functional structure of the information processing apparatus 100 as the embodiment. As shown in FIG. 5, the information processing apparatus 100 includes an input display unit 110, a distance calculation portion 120, a position calculation portion 130, a display change portion 140, a setting storage portion 150, and a memory 160.

The input display unit 110 is a functional portion which displays information and through which information is input. The input display unit 110 includes a detection unit 112 and a display unit 114. The detection unit 112 corresponds to the proximity touch sensor 105 shown in FIG. 1 and may be implemented using an electrostatic touch-sensitive panel. In this case, the detection unit 112 detects the value of capacitance that varies depending on the proximate distance between the operating body and the display surface of the display unit 114. As the operating body comes closer to the display surface than a predetermined distance, the capacitance detected by the detection unit 112 increases. The closer the operating body to the display surface, the larger the capacitance detected. When the operating body touches the display surface, the capacitance detected by the detection unit 112 is maximized. On the basis of the capacitance value thus detected by the detection unit 112, the distance calculation portion 120 (to be discussed later) can calculate the proximate distance of the operating body relative to the display surface of the display unit 114. The detection unit 112 outputs the detected capacitance value as the result of the detection to the distance calculation portion 120.

The result of the detection by the detection unit 112 identifies the position of the operating body on the display surface of the display unit 114. For this reason, the result of the detection is also output to the position calculation portion 130 (to be discussed later).

The display unit 114 corresponds to the display device 104 shown in FIG. 1 and serves as an output device that displays information. For example, the display unit 114 displays content piles 210 as well as the contents related to the content piles 210. When the display format of the content group 200 is changed by the display change portion 140, the display change portion 140 notifies the display unit 114 of display information about the content group 200 having undergone the display format change. In turn, the display unit 114 displays the content group 200 in the changed display format.

Based on the result of the detection input from the detection unit 112, the distance calculation portion 120 calculates the proximate distance between the operating body and the display surface of the display unit 114. As described above, the larger the capacitance value detected by the detection unit 120, the closer the operating body to the display surface. The capacitance value is maximized when the operating body touches the display surface. The relations of correspondence between the capacitance value and the proximate distance are stored beforehand in the setting storage portion 150 (to be discussed later). With the capacitance value input from the detection unit 112, the distance calculation portion 120 references the setting storage portion 150 to calculate the proximate distance between the operating body and the display surface. The proximate distance thus calculated is output to the display change portion 140.

Based on the result of the detection input from the detection unit 112, the position calculation portion 130 determines the position of the operating body on the display surface of the display unit 114. As will be discussed later in more detail, the process of changing the display format of the content group 200 is carried out when the operating body is within a determination region established with regard to the objects 200 making up the content group 200. The position calculation portion 130 calculates the position of the operating body on the display surface in order to determine whether or not to perform the process of changing the display format of the content group 200, i.e., so as to determine whether the operating is located within the determination region.

For example, suppose that the detection unit 112 is composed of an electrostatic sensor plate formed by an electrostatic detection grid for detecting x and y coordinates. In this case, the detection unit 112 can determine the coordinates of the operating body in contact with the plate (i.e., display surface) based on the change caused by the contact in the capacitance of each of the square parts constituting the grid. The position calculation portion 130 outputs position information denoting the determined position of the operating body to the display change portion 140.

In keeping with the proximate distance between the operating body and the display surface, the display change portion 140 changes the format in which the objects 210 are displayed on the display unit 114. On the basis of the proximate distance input from the distance calculation portion 120, the display change portion 140 determines whether the proximate distance of the operating body relative to the display surface is within the proximate region, i.e., a region within a predetermined distance from the display surface. Also, based on the position information about the operating body input from the position calculation portion 130, the display change portion 140 determines whether the operating body is located within the determination region on the display surface. If it is determined that the operating body is within both the proximate region and the determination region, the display change portion 140 changes the format in which the content group 200 is displayed in accordance with the proximate distance.

The format in which the content group 200 is displayed may be in an aggregate state or a preview state, for example. The aggregate state is a state in which a plurality of content piles 210 are overlaid with one another and shown aggregated. The preview state is a state where the content piles 210 are spread out so that the information written on each content pile is visible. The process performed by the display change portion 140 for changing the format in which the content group 200 is displayed will be discussed later. If it is determined that the display format of the content group 200 is changed, then display change portion 140 creates an image of the content group 200 following the display format change and outputs the created image to the display unit 114.

Also, the display change portion 140 changes the focused content pile 210 in accordance with the operating body's position on the display surface. On the basis of the position information about the operating body input from the position calculation portion 140, the display change portion 140 determines the focused content. The display change portion 140 proceeds to create a correspondingly changed image and output it to the display unit 114.

The setting storage portion 150 stores as setting information the information for use in calculating the proximate distance between the operating body and the display surface, creating the position information about the operating body on the display surface, and changing the format in which the content group 200 is displayed, among others. For example, the setting storage portion 150 may store the relations of correspondence between the capacitance value and the proximate distance. By referencing the stored relations of correspondence, the distance calculation portion 120 can calculate the proximate distance corresponding to the capacitance value input from the detection unit 112.

The setting storage portion 150 also stores determination regions each established for each content group 200 and used for determining whether or not to perform a display format changing process. By referencing the relevant determination region stored in the setting storage portion 150, the position calculation portion 130 determines whether the position information about the operating body identified by the result of the detection from the detection unit 112 indicates the operating body being located in the determination region of the content group 200 in question. Also, the setting storage portion 150 may store predetermined rules for determining the focused content pile 210. For example, the predetermined rules may include the relations of correspondence between the position of the finger F and the content piles 210 along with the relations of correspondence between the travel distance of the finger F and the focused content pile 210. The rules will be discussed later in more detail.

Furthermore, the setting storage portion 150 may store the proximate regions determined in accordance with the proximate distance between the operating body and the display surface. The proximate regions thus stored may be used to determine whether or not to carry out the display format changing process. For example, if the proximate distance between the operating body and the display surface is found shorter than a predetermined threshold distance and if that proximate distance is assumed to be a first proximate region, then the operating body moving into the first proximate region may serve as a trigger to change the display format of the content group 200. The proximate region may be established plurally.

The memory 160 is a storage portion that temporarily stores information such as that necessary for performing the process of changing the display format of the content group 200. For example, the memory 160 may store a history of the proximate distances between the operating body and the display surface and a history of the changes in the display format of the content group 200. The memory 160 may be arranged to be accessed not only by the display change portion 140 but also by such functional portions as the distance calculation portion 120 and position calculation portion 130.

### [Content Group Display Changing Process]

The information processing apparatus 100 functionally structured as explained above changes the display format of the content group 200 before the operating body touches the display surface, as described.

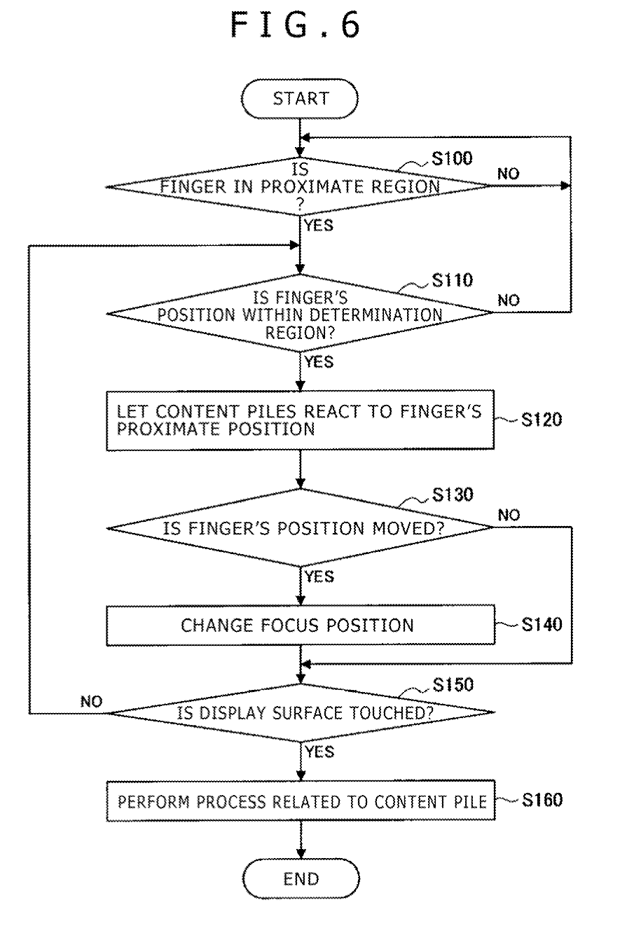

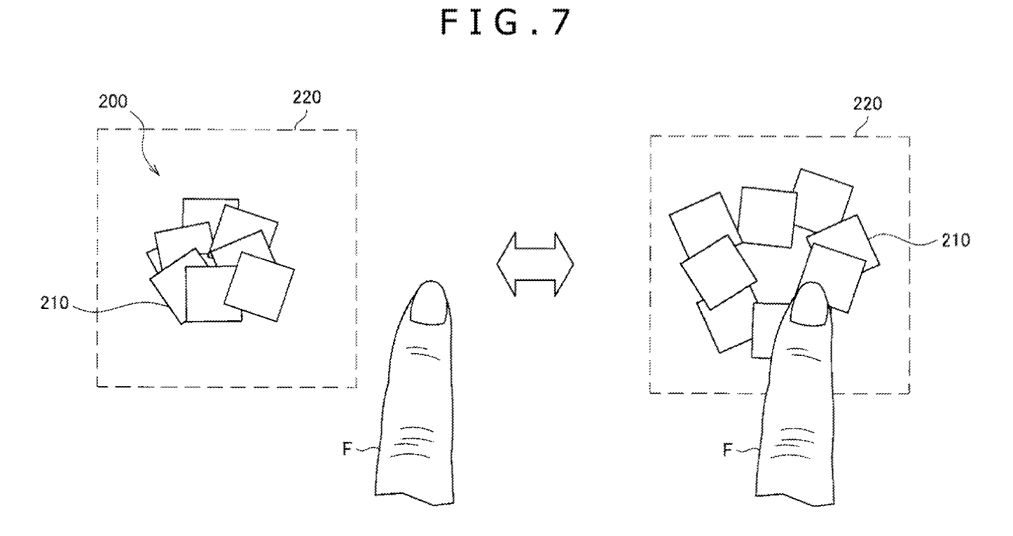

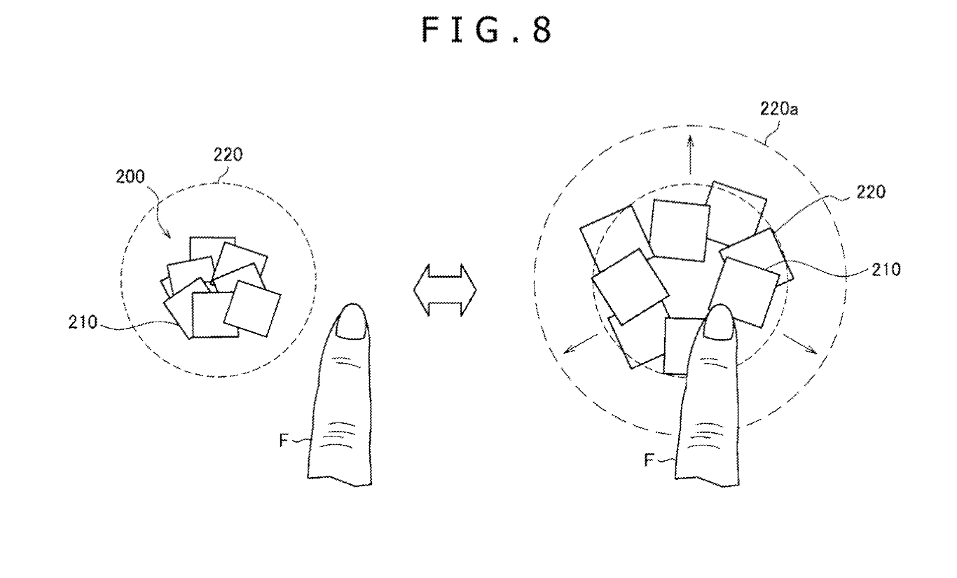

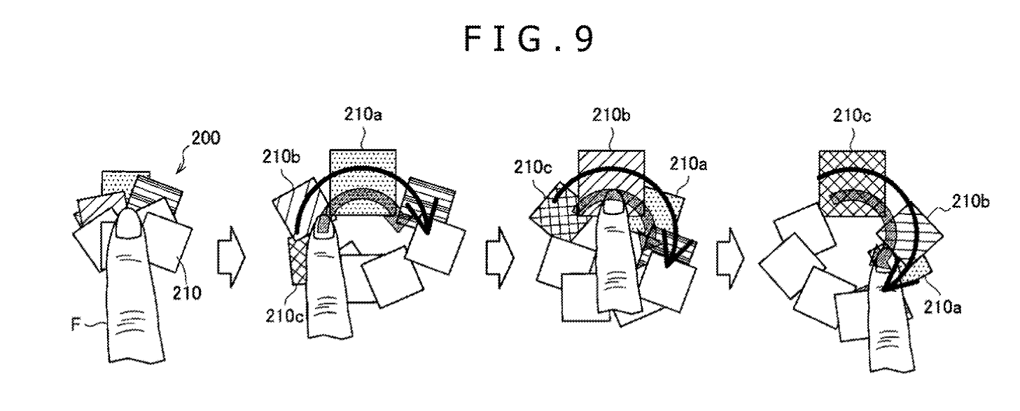

The display changing process on the content group 200 is explained below in reference to FIGS. 3 and 6 through 8. FIG. 6 is a flowchart showing a typical display changing process performed on the content group 200. FIG. 7 is an explanatory view showing a typical determination region 220, and FIG. 8 is an explanatory view showing another typical determination region 220.

In the display changing process performed by the information processing apparatus 100 on the content group 200, as shown in FIG. 6, the display change portion 140 first determines whether the finger F acting as the operating body is positioned within the proximate region (in step S100). For this preferred embodiment, the proximate region is defined as a region extending from the display surface of the display unit 114 to a predetermined perpendicular distance away from the display surface (see FIG. 4). The predetermined distance defining the proximate region is set to be shorter than a maximum distance that can be detected by the detection unit 112. As such, the distance may be established as needed with the device specifications and user preferences taken into consideration. The display change portion 140 compares the proximate distance calculated by the distance calculation portion 120 based on the result of the detection by the detection unit 112, with the predetermined distance. If the proximate distance is found shorter than the predetermined distance, the display change portion 140 determines that the finger F is within the proximate region, executing the process of step S110; if the proximate distance is found longer than the predetermined distance, the display change portion 140 determines that the finger F is outside the proximate region. Step S100 is thus repeated.

If it is determined that the finger F is within the proximate region, the display change portion 140 determines whether the finger F is positioned within the determination region (in step S110). As explained above, the determination region is established corresponding to each of the content groups 200 and is used to determine whether or not to perform the process of changing the format in which the content group 200 in question is displayed. Each determination region is established in such a manner as to include the corresponding content group 200.

For example, as shown in FIG. 7, a rectangular determination region 220 may be established in a manner encompassing the content group 200. If the finger F is not found positioned within the determination region 220, the display format of the content group 200 corresponding to the determination region 220 in question is not changed, and the content piles 210 remains overlaid with one another. If the finger F is found positioned within the determination region 220, the display format of the content group 200 corresponding to the determination region 220 is changed in such a manner that the content piles 210 are spread out as shown in the right-hand subfigure of FIG. 7. In this state, the information written on each of the content piles 210 becomes recognizable. Later, when the finger F is moved out of the determination region 220, the spread-out content piles 210 are again aggregated into a single position.

In another example, as shown in FIG. 8, a substantially circular determination region 220 may be established to surround the content group 200. In this case, as in the example of FIG. 7, if the finger F is not found positioned within the determination region 220, the display format of the content group 200 corresponding to this determination region 220 is not changed, and the content piles 210 remain overlaid with one another. If the finger F is found positioned within the determination region 220, the display format of the content group 200 corresponding to the determination region 220 is changed in such a manner that the content piles 210 are spread out as shown in the right-hand subfigure of FIG. 8. In this state, the information written on each of the content piles 210 becomes recognizable. Later, when the finger F is moved out of the determination region 220, the spread-out content piles 210 are again aggregated into a single position.

The shapes and sizes of the determination region 220 are not limited to those shown in the examples of FIGS. 7 and 8, and may be changed as needed. Where the content piles 210 are displayed spread out as shown in the right-hand subfigure of FIG. 8, the determination region 220 may be expanded correspondingly (e.g., expanded determination region 220a). If the determination region 220 is fixed to an insufficient size and if the content piles 210 are designed to stay within the determination region 220 when spread out, there is a possibility that some of the content piles 210 will remain overlaid with one another when spread out. This can prevent the information written on each content pile 210 from becoming fully recognizable. On the other hand, if the determination region 220 is set to be inordinately large, then the finger F moving away from the content group 200 may still be located within the determination region 220, which can render image operations difficult to perform.

If the content piles 210 are allowed to spread out of the determination region 220, then some of the content piles 220 may indeed move out of the determination region 220 when they are spread out. In such a case, it might happen that the user wants to select a content pile 210 outside the determination region 220 and moves the finger F out of the determination region 220. This will cause the content piles 210 to be aggregated before any of them can be selected as desired. These problems can be solved typically by changing the size of the determination region 220 in proportion to the spread-out state of the content piles 210.

Returning to the explanation of FIG. 6, it may be determined in step S110 that the finger F is positioned within the determination region 220 established for the content group 200. In that case, the display change portion 140 determines that the display format of the content group 200 is to be changed (in step S120). Where the finger F is found within the proximate region and also inside the determination region 220, it may be considered that the user is moving the finger F closer to the display surface to select a content pile 210. In this case, as shown in state (b) of FIG. 3, the content piles 210 may be spread out from their aggregated state to such an extent that the information written on each content pile 210 becomes visible for the user to check. If it is determined in step S110 that the finger F is not positioned within the determination region 220, the display format of the content group 200 is not changed. Step S100 is then reached again and the subsequent steps are repeated.

If the finger F is found positioned within the determination region 220, the display change portion 140 displays the content group 200 in a spread-out manner and focuses on one of the content piles 210 making up the content group 200. The focused content pile 210 is displayed magnified as in the case of the content pile 210a in state (b) of FIG. 3. Alternatively, it is possible to inform the user of the currently focused content pile 210 by highlighting the content pile 210 in question or enclosing it with a frame.

The focused content pile 210 may preferably be positioned close to the tip of the finger F. For example, if the content piles 210 are spread out circularly as shown in FIG. 3 with the finger F extended from below as viewed on the plan view, and if the focused content pile 210 is displayed near the base of the finger F, then the focused content pile 210 might be hidden by the finger F preventing the user from checking the content of the content pile 210 of interest. The focused content 210 may be left visible when displayed close to the tip of the finger F.

Thereafter, the display change portion 140 determines whether the position of the finger F has moved on the basis of the input from the position calculation portion 130 (in step S130). If it is determined that the position of the finger F has moved based on the position information about the finger F, the'display change portion 140 changes the focused content pile 210 in keeping with the movement of the finger F (in step S140). In the example of FIG. 3, as the finger F is moved rightward, the content piles 210 spread out in a circle are rotated clockwise. Conversely, when the finger F is moved leftward, the circularly spread-out content piles 210 are rotated counterclockwise. By moving the position of the finger F on the display surface in this manner, the user can change the focused content pile 210 and visually check the content of the individual content piles. If it is determined in step S130 that the finger F has not moved in position, then the position of the focused content pile 210 remains unchanged.

The display change portion 140 then determines whether the finger F has touched the display surface (in step S150). If the capacitance value resulting from the detection performed by the detection unit 112 is found larger than a predetermined capacitance value at contact time, the display change portion 140 estimates that the finger F has touched the display surface. At this point, if a content pile 210 is positioned where the finger F has touched the display surface, then the display change portion 140 carries out the process related to the content pile 210 in question (in step S160). For example, if a content is related to a given content pile 210 and if that content pile 210 is selected, then the related content is performed.

If in step S130 any touch by the finger F on the display surface is not detected, then step S110 is reached again and the subsequent steps are repeated. Later, if the finger F is detached from the display surface and moved out of the proximate region, the display change portion 140 again aggregates the content piles 210 shown spread out into a single position as indicated in the right-hand subfigure of FIG. 4. In this manner, the information processing apparatus 100 as the preferred embodiment changes the display format of the content group 200 in accordance with the proximate distance between the finger F and the display surface. When the finger F is positioned within the proximate region, the focused content pile 210 is changed in keeping with the position of the finger F on the display surface.

As explained above in reference to FIG. 3 showing the display change example, when the finger F is positioned within the proximate distance, the content group 200 is spread out in a circle and one of the content piles 210 making up the content group 200 is focused. As the user moves the finger F rightward or leftward, the focused content pile 210 is changed correspondingly. However, this example is not limitative of the way the focused content pile 210 is to be changed. For example, as shown in FIG. 9, the position of the focused content pile 210 may be changed by moving the finger F in a circle to trace the circularly spread-out content group 200. The user can perform image operations intuitively because the movement of the finger F corresponds to the motion of the content group 200 in its display format.

The foregoing paragraphs explained how the information processing apparatus 100 as the preferred embodiment performs the display format changing process on the content group 200. According to the process, the user can select the content group 200 and view the information written on each of the content piles 210 constituting the selected content group 200 by simply changing the finger position on the display surface. A desired one of the content piles 210 making up the content group 200 may then be focused so that detailed information about the focused content pile is made visible for check.

Furthermore, bringing the finger F into contact with the desired content pile 210 permits selection of the content pile 210 and execution of the process related to the selected content pile 210. The information processing apparatus 100 as the preferred embodiment allows its user to perform the above-described operations in a series of steps offering easy-to-operate interactions.

### <2. Variations>

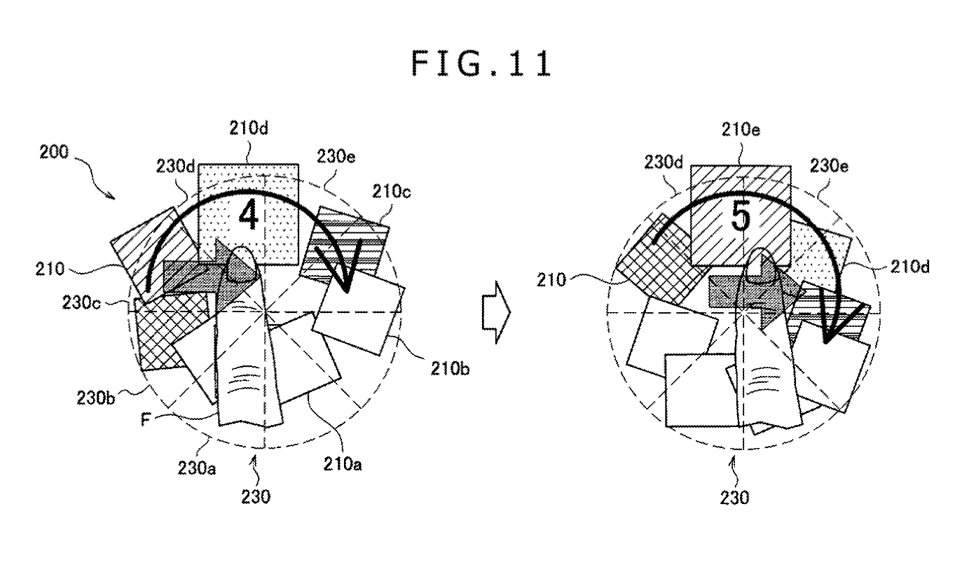

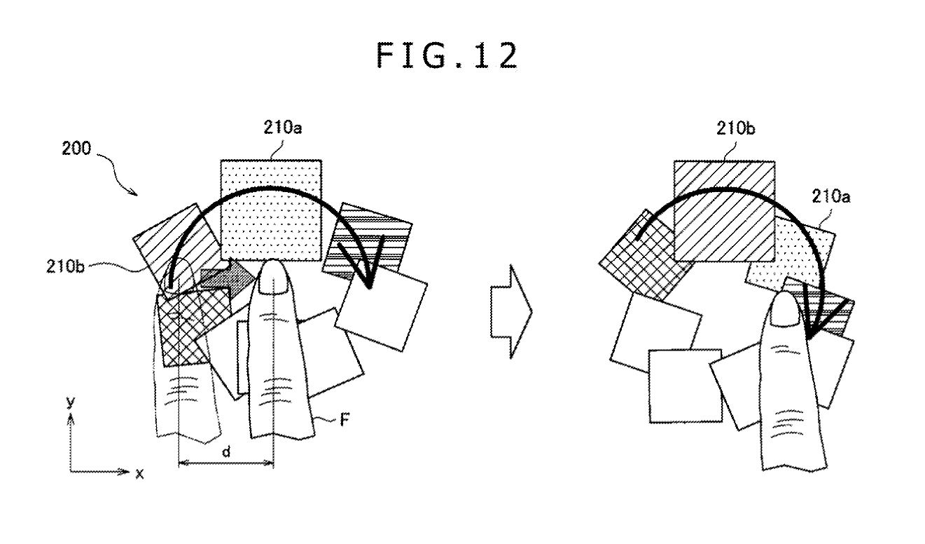

The information processing apparatus 100 considers the above-described display changing process on the content group 200 to be the basis process that can be used in various situations and applications and developed in diverse manners. Explained below in reference to FIGS. 11 through 15 are some applications of the display changing process on the content group 200.

### [Changing the Content Focus Position]

In the foregoing examples, the focused content pile 210 in the spread-out content group 200 was shown changed in accordance with the direction of finger movement. Alternatively, the information processing apparatus 100 as the preferred embodiment may have the focus position of the content piles 210 changed according to some other suitable rule.

### (Setting the Focus Position Determination Region (Rectangular))

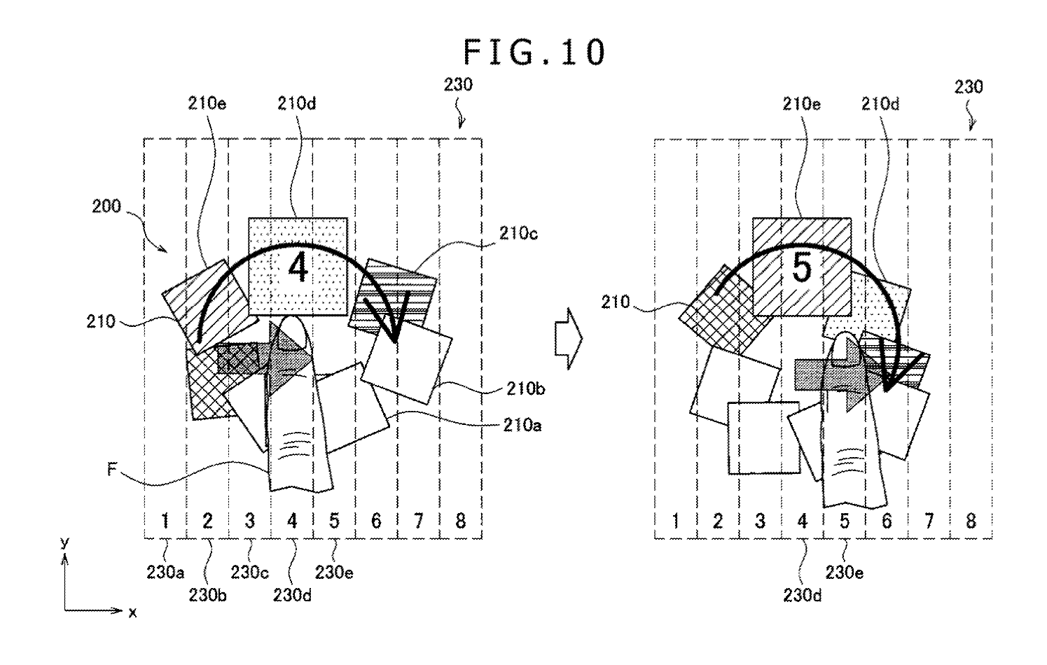

For example, a region identical to or inside of the determination region 220 may be established as a focus position determination region 230 for determining the focus position, as shown in FIG. 10. The focus position determination region 230 is divided in a predetermined direction (e.g., x-axis direction in FIG. 10) into as many parts as the number of the displayed content piles 210. The divided parts (also called sub-regions) making up the focus position determination region 230 correspond individually to the displayed content piles 210. In FIG. 10, a first content pile 210a is set corresponding to a first sub-region 230a, a second content pile 210b corresponding to a second sub-region 230b, and so on.

In the left-hand subfigure of FIG. 10, the finger F is positioned in a fourth sub-region 230d of the focus position determination region 230, so that a fourth content pile 21d is focused accordingly. Later, when the finger F is moved rightward (in the positive x-axis direction) and positioned inside a fifth sub-region 230e as shown in the right-hand subfigure of FIG. 10, the display change portion 140 recognizes the changed finger position based on the position information input from the position calculation portion 130. The display change portion 140 proceeds to rotate clockwise the displayed content piles 210 by one sub-region, thereby displaying a fifth content pile 210e in the focus position. In this manner, when the sub-regions 230 are set beforehand corresponding to the content piles 210, the focused content pile 210 can be determined in accordance with the absolute position of the finger F relative to the display surface. The relations of correspondence between the sub-regions 230 and the content piles 210 may be stored in the setting storage portion 150.

### (Setting the Focus Position Determination Region (Circular))

Likewise, the focus position determination region 230 may be set circularly as shown in FIG. 11. In this case, the sub-regions may be set by dividing the center angle of the focus position determination region 230 into as many equal parts as the number of the displayed content piles 210. That is, this example is characterized in that the absolute position of the finger F is set corresponding to the angle. In the left-hand subfigure of FIG. 11, the finger F is positioned in the fourth sub-region 230d of the focus position determination region 230, so that the fourth content pile 210d corresponding to the fourth sub-region 230d is focused. Later, when the finger F is rotated clockwise and positioned into a fifth sub-region 230e as shown in the right-hand subfigure of FIG. 11, the display change portion 140 recognizes the changed finger position based on the position information input from the position calculation portion 130. The display change portion 140 proceeds to rotate the displayed content piles 210 clockwise by one sub-region, thereby displaying the fifth content pile 210e in the focus position.

(Changing the Focus Position in Keeping with the Amount of Finger Movement)

Alternatively, the focus position of the content piles 210 may be changed in keeping with the amount of movement of the finger F. For example, there may be set a unit movement amount du of the finger F for moving the focus position to the next content pile 210. When the finger F is moved by a distance d in the positive x-axis direction as shown in the right-hand subfigure of FIG. 12, a content pile 210 is focused by moving the focus position by as many unit movement amounts du as are included in the distance d. In the example of FIG. 12, it is held that du≦d<2du so that the display change portion 140 moves the focus position from the content pile 210a to the next content pile 210b.

### [Execution of the Functions of a Content Group/Contents]

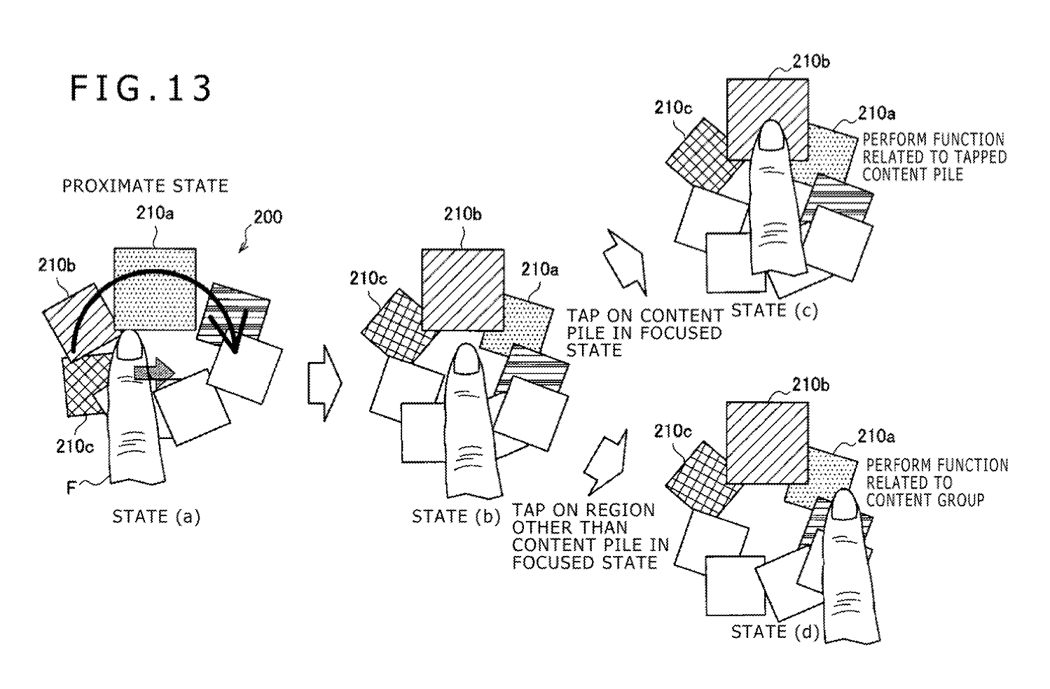

The foregoing paragraphs explained how the display format of the content group 200 may be changed and how the focus position of the content piles 210 making up the spread-out content group 200 may be operated on. Functions are assigned to the displayed content group 200 or to each of the displayed content piles 210. The user can execute such functions by performing corresponding operations. Some typical operations for function execution are shown in FIG. 13.

When the finger F is positioned close to the proximate region as indicated in state (a) of FIG. 13, the content group 200 is displayed spread out in a circle. Suppose now that the content pile 210a is currently focused. In this case, if the user moves the finger F rightward or leftward, the focused content pile 210 is changed correspondingly. For example, the focus may be shifted from the content pile 210a to the content pile 210b as shown in state (b) of FIG. 13.

Suppose that the user later touches his or her finger F to, and taps on, the focused content pile 210b (in state (c)). In this case, the display change portion 140 recognizes the operations based on the input from the distance calculation portion 120 and position calculation portion 130, and a function execution portion (not shown) of the information processing apparatus 100 executes the function related to the tapped content pile 210b accordingly. On the other hand, suppose that the user touches the finger F to, and taps on, a content pile 210 other than the focused content pile 210b (in state (d)). In this case, the display change portion 140 recognizes the operations based on the input from the distance calculation portion 120 and position calculation portion 130, and the function execution portion of the information processing apparatus 100 executes the function related to the content group 200.

As described, the position where the user carries out certain operations for function execution determines the function that is carried out by the function execution portion. Thus it is possible directly to perform the function related to a given content pile 210 or carry out the function related to the content group 200. Although the preceding examples showed that the user taps on the target object for function execution, this is not limitative of the present disclosure. Alternatively, if the sensor in use can detect a continuous hold-down operation, a press-down operation or the like, then the target object may be held down continuously or operated otherwise to execute the function. If an input device is used to perform a pointing operation, the user may set a click operation or the like on the device as the operation for function execution.

### [Canceling the Operation Input]

When one of the content piles 210 making up the spread-out content group 200 is focused, the focused state may be canceled by carrying out predetermined operation input. For example, during an ongoing operation to move the focus position of the content piles 210 in the spread-out content group 200, it may be arranged to cancel the operation to move the focus position by stopping the movement of the finger F for a predetermined time period or longer. Alternatively, it may be arranged to cancel the operation to move the focus position of the content piles 210 by moving the finger F out of the determination region 220 or by moving the finger F in a direction substantially perpendicular to the moving direction of the finger F moving the focus position.

When the input of the operation to cancel the current state of operation is detected from the result of the detection performed by the detection unit 112, the display change portion 140 cancels the current state of operation. If the finger F is moved in the moving direction of the finger F moving the focus position after the current state of operation is canceled, then the screen may be scrolled or some other function may be carried out in response to the operation input.

### [Variations of Content Group Display]

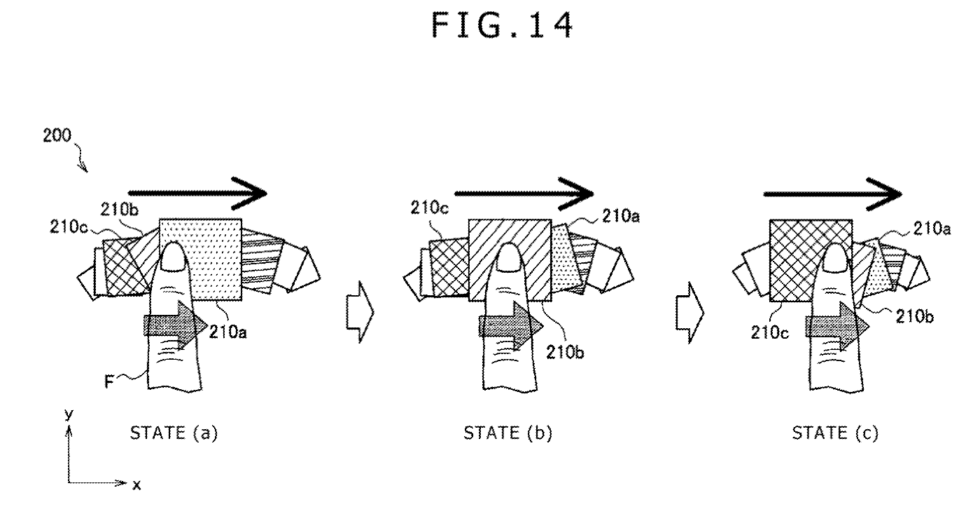

The foregoing examples showed that a plurality of content piles 210 making up the content group 200 are displayed overlaid with one another in one location in the aggregated state and that in the spread-out state, the content piles 210 are displayed in a circle to let the information written thereon become visible for check. However, this is not limitative of the present disclosure. Alternatively, the content piles 210 making up the content group 200 may be displayed in a straight line when spread out, as shown in FIG. 14. In this case, the focused content pile 210 is also displayed larger than the other content piles 210. In state (a) of FIG. 14, the content pile 210a is focused, with the other content piles (210b, 210c, . . . ) displayed smaller than the content pile 210a.

Later, when the finger F is moved in the x-axis direction, an enlarged content pile display is shifted progressively to the content piles 210b, 210c, etc., in keeping with the finger movement (in states (b) and (c)). That is, when the content group 200 is spread out in a straight line, the content piles 210 making it up can still be operated on in the same manner as when the content group 200 is spread out in a circle.

Where the content piles 210 constituting the content group 200 are spread out linearly in the x-axis direction, the finger F is moved in the x-axis direction, i.e., in the direction in which the content piles 210 are spread out, so as to change the focused content pile 210. During that finger movement, the finger F may be shifted in the y-axis direction, i.e., perpendicularly to the direction in which the content piles are spread out. If the amount of shift in the y-axis direction is tolerably small, the shift is considered an operation error. If the amount of shift in the y-axis direction is larger than a predetermined amount, the perpendicular shift is considered intentional. In this case, the process of focus position movement may be canceled and the function related to the finger's shift may be carried out. For example, if the finger's shift in the y-axis direction is found larger than the predetermined amount, the function related to the currently focused content pile 210 may be performed.

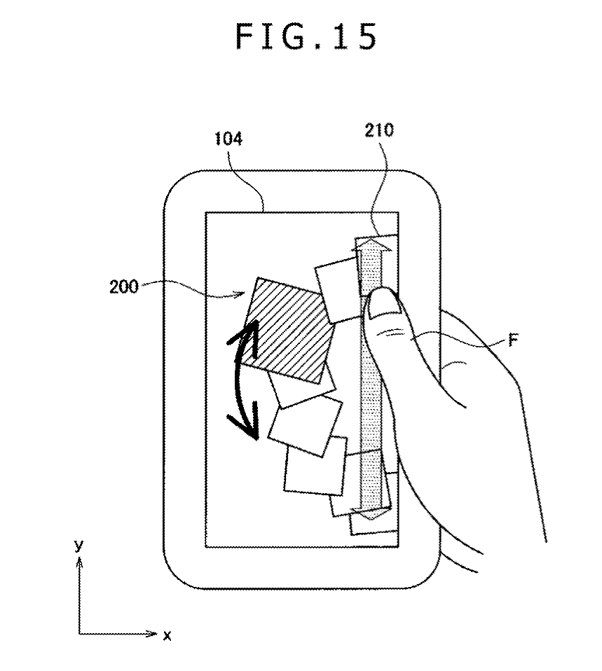

In the foregoing description, the focused content pile 210 in the circularly spread-out content group 200 was shown changed by moving the finger F in the x-axis direction. However, this is not limitative of the present disclosure. Alternatively, the focused content pile 210 may be changed by moving the finger F in, say, the y-axis direction. In this case, as shown in FIG. 15, the content group 200 may be displayed spread out in a semicircle on the display device 104, and the chord part of a crescent shape formed by the content piles 210 may be set to be parallel with one screen side of the display device 104. When the finger F is moved up and down (in the y-axis direction) on the displayed chord part of the crescent-shaped content group 200, the display device 140 may move the display position of the content piles 210 so as to change the focused content pile.

The functionality of the information processing apparatus 100 as the preferred embodiment of the present disclosure was described above in conjunction with the display changing process performed thereby on the content group 200. According to this embodiment, it is possible for the user to check the information written on the displayed content piles 210 making up the content group 200 without significantly altering the display mode in effect. Because the information on the content piles 210 constituting the content group 200 can be checked by simply moving the position of the operating body or of the pointing position on the screen, intuitive browsing is implemented without interference with other operations or with no special operations to be carried out. Furthermore, given the spread-out content group 200, functions related to the content group 200 or to each of the content piles 210 making up the content group 200 may be carried out. This feature helps reduce the number of the operating steps involved.

It is to be understood that while the disclosure has been described in conjunction with specific embodiments with reference to the accompanying drawings, it is evident that many alternatives, modifications and variations will become apparent to those skilled in the art in light of the foregoing description. It is thus intended that the present disclosure embrace all such alternatives, modifications and variations as fall within the spirit and scope of the appended claims.

For example, the above-described preferred embodiment was shown having the display unit 114 display collectively all content piles 210 included in the content group 200. However, this is not limitative of the present disclosure. Alternatively, if there are numerous content piles 210 included in the content group 200, the display unit 114 may limit the number of displayed content piles 210 to the extent where the information on each of the content piles 210 is fully visible while the content group 200 is being spread out inside the display region of the display unit 114.

In such a case, the content piles 210 that stay off screen may be displayed as follows: the focused content pile 210 is changed by moving the finger F. After all the displayed content piles 210 have each been focused, the content piles 210 displayed so far are hidden and replaced by the content piles 210 hidden so far. That is, after the content piles 210 have each been focused in the current batch, the next batch of content piles 210 is displayed. In this manner, all content piles 210 included in the content group can each be focused.

The present disclosure contains subject matter related to that disclosed in Japan Priority Patent Application JP 2010-169104 filed in the Japan Patent Office on Jul. 28, 2010, the entire content of which is hereby incorporated by reference.

What is claimed is:

1. An information processing apparatus comprising:
a detection unit configured to detect the position of an operating body relative to a display surface of a display unit displaying an object group made up of a plurality of objects each being related to a content; and
a display change portion configured to change a focus position of said objects making up said object group based on a result of the detection performed by said detection unit; wherein
based on the result of the detection, if said detection unit has detected said operating body moving linearly in a predetermined operating direction thereof substantially parallel to said display surface, then said display change portion changes the focus position of said objects spread out circularly to make up said object group, in a manner moving said focus position in the spread-out direction.

2. The information processing apparatus according to claim 1, wherein said display change portion changes the format in which said object group is displayed based on a proximate distance between said display surface and said operating body, said proximate distance being acquired from the result of the detection performed by said detection unit.

3. The information processing apparatus according to claim 1, wherein, based on the result of the detection, if said detection unit has detected said operating body moving in a direction substantially perpendicular to said predetermined operating direction, then said display change portion determines to select the content related to the currently focused object.

4. The information processing apparatus according to claim 1, wherein said display change portion changes the focus position of said objects making up said object group in accordance with the amount by which said operating body has moved relative to said display surface.

5. The information processing apparatus according to claim 1, wherein said object group is furnished with a determination region including said objects; wherein
said determination region is divided into as many sub-regions as the number of said objects included in said object group, said sub-regions corresponding individually to said objects; and
said display change portion focuses on the object corresponding to the sub-object on which said operating body is detected to be positioned based on the result of the detection performed by said detection unit.

6. The information processing apparatus according to claim 5, wherein said display change portion changes said determination region in such a manner as to include said content group in accordance with how said content group is spread out.

7. The information processing apparatus according to claim 5, wherein, if said operating body is detected to have moved out of said determination region based on the result of the determination performed by said detection unit, then said display change portion displays in aggregate fashion said objects making up said object group.

8. The information processing apparatus according to claim 1, wherein said display change portion highlights the currently focused object.

9. The information processing apparatus according to claim 1, wherein said display change portion displays the currently focused object close to the tip of said operating body.

10. The information processing apparatus according to claim 1, wherein, if an operation input is not detected for longer than a predetermined time period based on the result of the detection performed by said detection unit, then said display change portion stops changing the focus position of said objects making up said object group.

11. An information processing method comprising:
causing a detection unit to detect the position of an operating body relative to a display surface of a display unit displaying an object group made up of a plurality of objects each being related to a content;
causing a display change portion to change a focus position of said objects making up said object group based on a result of the detection performed by said detection unit; and
based on the result of the detection, if said detection unit has detected said operating body moving linearly in a predetermined operating direction thereof substantially parallel to said display surface, then causing said display change portion to change the focus position of said objects spread out circularly to make up said object group, in a manner moving said focus position in the spread-out direction.

12. A computer program for causing a computer to function as an information processing apparatus comprising:
a detection unit configured to detect the position of an operating body relative to a display surface of a display unit displaying an object group made up of a plurality of objects each being related to a content; and
a display change portion configured to change a focus position of said objects making up said object group based on a result of the detection performed by said detection unit; wherein
based on the result of the detection, if said detection unit has detected said operating body moving linearly in a predetermined operating direction thereof substantially parallel to said display surface, then said display change portion changes the focus position of said objects spread out circularly to make up said object group, in a manner moving said focus position in the spread-out direction.
